(19) United States
(12) Patent Application Publication
(10) Pub. No.: US 2010/0071628 A1
(43) Pub. Date: Mar. 25, 2010

(54) Portable Waste box and Absorbent Pad Holder for Housebreaking Dogs

(76) Inventor: Killian Mathew Wells, Encino, CA (US)

Correspondence Address: BERENATO & WHITE, LLC, 6550 ROCK SPRING DRIVE, SUITE 240, BETHESDA, MD, 20817, US

(21) Appl. No.: 12/235,430

(22) Filed: Sep. 22, 2008

(51) Int. Cl. A01K 29/00

(52) U.S. Cl. 119/169; 119/165; 119/174

(57) ABSTRACT

A portable box-like carrier with an insert which holds absorbent pads that are easily found in any pet store and allows dogs to eliminate indoors inside a designated area and makes clean-up easy and sanitary. The waste box can be used as an easy solution to housebreak dogs and as a permanent indoor toilet fixture thereafter. The device eliminates the problems associated with other indoor housebreaking and dog waste disposal methods and brings the qualities of both a lifter box and absorbent pad into one product. The device is a portable, suitcase style box that can travel easily and uses a nesting insert that makes clean up more sanitary by keeping a portion of the absorbent pad from contamination.

### BACKGROUND OF THE INVENTION

1. Field of the Invention

The invention relates to a device for housetraining pets and for providing a portable potty for pets.

2. Description of Related Art

In this day and age small dogs known as toy or miniature breeds are rapidly becoming increasingly popular over the larger variety, especially for those living in congested metropolitan areas such as New York City where small apartments won't house a large dog comfortably. Many small dog owners opt to housebreak their pet to eliminate inside on an absorbent pad or in a litter box to save them the trouble of having to take the dog out multiple times a day due to cold weather or time restraints resulting from a job. The problem with either of these methods is that they can be very messy and/or difficult to achieve acceptable behavioral results on the dog's part. Litter boxes can lead to dogs eating the litter and leaving pieces of it around the home while pads can easily be torn apart and look unsightly on the floor.

### SUMMARY OF THE INVENTION

A combination portable waste box and absorbent pad holder for housebreaking pets, comprising a portable carrier having four sidewalls and a bottom; a door attached to the portable carrier and movable from an opened to a closed position. The door has a perimeter corresponding to a perimeter defined by the four sidewalls so that the door will substantially close the portable carrier when in a closed position. An insert having a plurality of inner sidewalls is sized to fit within the portable carrier. The insert has an open top and an open bottom. An absorbent pad is sized to fit within the portable carrier in such a manner that the absorbent pad is sandwiched between an edge in the insert defining the open bottom and the bottom of the portable carrier in order to retain the absorbent pad in place. The portable waste box may be used as an easy solution to housebreak dogs and as a permanent indoor toilet fixture thereafter.

### BRIEF DESCRIPTION OF THE DRAWINGS

FIG. 1 is an exploded view showing the primary components for the preferred embodiment of the invention.

FIG. 2 shows the invention in its assembled state with the image of a pet.

FIG. 3 shows the preferred embodiment of the invention in a closed position.

### DETAILED DESCRIPTION OF PREFERRED EMBODIMENTS

As will be described below with reference to the drawings, the present invention eliminates the problems associated with other indoor housebreaking and dog waste disposal methods and brings the qualities of both a litter box and absorbent pad into one product. Unlike existing prior art, this portable device is preferably a suitcase style box that can travel easily and uses a nesting insert that makes clean up more sanitary by keeping a portion of the absorbent pad from contamination.

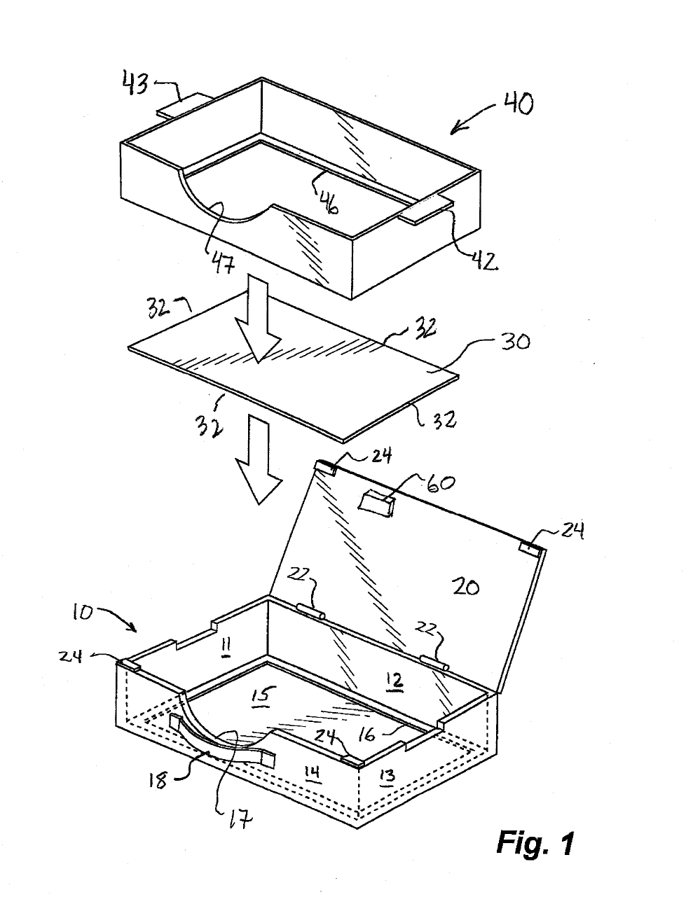

With reference to FIG. 1, a portable carrier unit 10 comprises four sidewalls 11, 12, 13, 14 and a bottom 15 with a rectangular dimple/groove or other type of interface 16 (shown as a ridges about ¼″ thick) around the perimeter of the bottom 15 where the user places a standard absorbent pad over 30. In the preferred embodiment, the door 20 is hinged to the sidewall 12 via hinges 22. The door 20 folds forward to become a top for portability. It may be secured with magnets 24 or some other type of fastener. While the preferred embodiment utilizes a hinged door 20, it should be understood that the door 20 may be a separate element that may be placed on the portable carrier 10 to close the same or may interface with the carrier 10 in different ways without departing from the spirit and scope of this invention.

The front sidewall 14 may have a U-shaped dip or cut-out 17 so pets can easily get in and out of the carrier assembly. Additionally, the front sidewall 14 may have a permanent handle 18 attached for carrying the assembly as you would a suitcase.

Referring to FIG. 1, an open (no top or bottom) rectangular insert 40 with optional side handles 42, 43 nests inside the perimeter of the main box or carrier 10. In the preferred embodiment, the insert 40 nests within the carrier 10 in much the same way as a Russian “Matryoshka” doll-within-a-doll and sets into the dimples or interface 16 in the bottom wall 15 of the carrier to push down and secure the edges of an absorbent waste pad 30 in place. More specifically, the insert 40 is provided with a complimentary edge or other type of interface 46 that is designed to mate with the interface 16 of the carrier 10 to positively secure the absorbent pad 30 in place by sandwiching the pad 30 to prevent the pet from dislodging the pad 30 during everyday use.

In the preferred embodiment, the front inner sidewall of the insert has a U-shaped cutout to line up uniformly with the cut-out 17 in the main waste box or carrier 10.

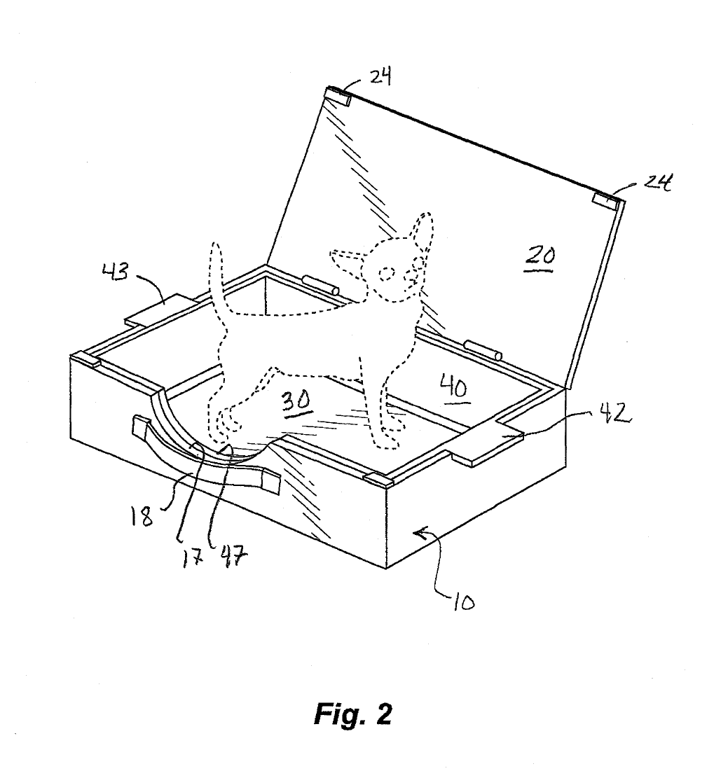

FIG. 2 shows the components of FIG. 1 in the assembled state with the insert 40 nesting within the carrier 10 and the absorbent pad 30 having its peripheral edges 32 sandwiched by the complimentary interfaces 16, 46 provided in the insert 40 and the carrier 10. It is noted that the interface may take any form necessary to secure the perimeter of the absorbent pad 30 in place when the insert 40 is nested within the carrier 10.

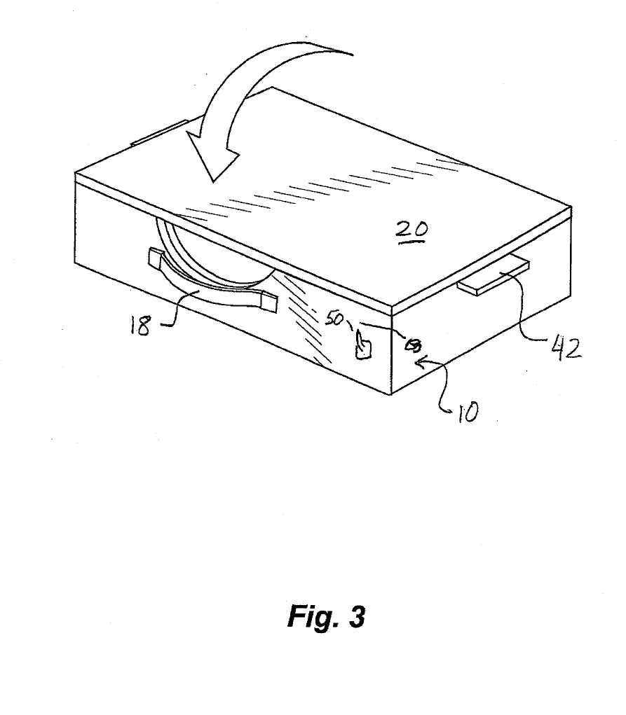

FIG. 3 shows the carrier in the closed condition with the door 20 covering the top of the carrier to form the suitcase-like structure.

The operation of the device illustrated in FIGS. 1-3 will now be described. To use, the user removes the locking insert 40 from the main waste carrier 10, places an absorbent pad 30 in the main waste carrier 10 and allows the peripheral edges 32 of the pad 30 to cover the dimple or interface 16 around the perimeter of the bottom 15 of the carrier 10. Then, the user picks up the locking insert 40 and places it into the main waste carrier 10, pressing down with enough effort to fold or sandwich the perimeter edges 32 of the pad 30 into the base dimples 16 with pressure and locks the pad 30 in place so it cannot be removed by a pet. When it's time to replace the pad 30, the user simply removes the insert 30 by lifting it out by the side handles 42, 43 and pulls the pad 30 out by two exposed edges.

It will be understood by those of skill in the art that various changes in form and detail may be made to the preferred embodiment shown and described without departing from the spirit and scope of the invention. For example, a hook 50 may be provided on one or more of the sidewalls 11, 12, 13, 14 with the intention of holding a waste scoop (See FIG. 3, scoop not shown). Optionally, a battery or electric powered automatic air purifier/fragrance diffuser 60 may be provided to eliminate odor (see FIG. 1).

In the preferred embodiment, the carrier 10 and insert 40 are made of high-impact acrylic plastic in a rectangular shape with the main waste carrier 10 having four “walls” and a taller hinged door 20 which folds down and secures with magnets. Of course, the device may take many forms and shapes. Likewise, the carrier 10 and insert 40 may be made from a variety of materials other than plastic including but not limited to wood, aluminum, composites, etc. The hinged door may have a space for a removable, battery powered air freshener. The sidewalls of the carder or hinged door may have a plastic hook made to hang a waste scoop on to remove feces from the pad without having to change it. The invention preferably has a handle on the front sidewall 14 for portability. The main waste carrier component 10 is provided with an interface in the form of a groove 16 in the bottom 15 whereby the locking insert 40 is provided with a complimentary interface 46 that fits inside of interface 16. The locking insert 40 preferably has tabs/handles 42, 43 on opposite sidewalls to permit easy removal of the insert 40 from the carrier 10.

The use of a removable, nesting insert 40 allows for easy pad replacement and also allows the user to wash the insert 40 over a sink or bathtub without having to wash the main waste carrier 10. Since the insert holds the edges of a disposable pad 30 and keeps that section from contamination with urine or feces the user can easily change a pad 30 without ever having to touch something unsanitary. With its U-shaped dip or cut-out 17 in the front of the waste carrier 10, dogs can easily get in and out while still protecting against leaks on the floor. The use of a box 10 in this invention also sets better boundaries when housebreaking a puppy or adult dog, forcing them to associate being within the four walls instead of just eliminating in the general vicinity of a pad.

The absorbent pad 30 is preferably an off-the-shelf product sold in pet stores but it may be selected from any group of pads used to absorb pet waste and/or assist in the training of pets.

The scope of the invention should not be limited to embodiments shown and described but it should encompass a scope defined by the following claims.

1. A combination portable waste box and absorbent pad holder for housebreaking pets, comprising:
a portable carrier having four sidewalls and a bottom;
a door attached to said portable carrier and movable from an opened to a closed position, said door having a perimeter corresponding to a perimeter defined by said four sidewalls so that said door will substantially close said portable carrier when in a closed position;
an insert having a plurality of inner sidewalls, said insert being sized to fit within said portable carrier, said insert having an open top and an open bottom;
an absorbent pad sized to fit within said portable carrier,
wherein said absorbent pad is sandwiched between an edge in said insert defining said open bottom and said portable carrier in order to retain said absorbent pad in place, whereby said portable waste box may be used as an easy solution to housebreak dogs and as a permanent indoor toilet fixture thereafter.

2. The combination according to claim 1, wherein said portable carrier comprises a handle for carrying said portable carrier.

3. The combination according to claim 1, wherein said portable carrier comprises a cutout in at least one of said sidewalls to make it easier for said pet to enter said portable carrier

4. The combination according to claim 3, wherein said cutout is unshaped.

5. The combination according to claim 1, wherein said door is pivotably attached to said portable carrier.

6. The combination according to claim 1, wherein said insert nests inside said main portable carrier.

7. The combination according to claim 3, wherein said insert comprises a matching cutout in one of said inner sidewalls, said matching cutout substantially matching said cutout in said portable carrier.

8. The combination according to claim 1, wherein said insert comprises handles to facilitate removal of said insert from said portable carrier.

9. The combination according to claim 1, wherein said insert and said portable carrier define a mating interface around said open bottom to further secure said absorbent pad in place within said portable carrier when said insert is nested within said portable carder.

10. The combination according to claim 1, wherein, during use, a user removes said insert from the portable carrier, places a pad in the portable carrier and allows the peripheral edges of said absorbent pad to be secured by a portion of said mating interface provided in said portable carrier.

11. The combination according to claim 10, wherein a user places the insert into said portable carrier to sandwich and secure said absorbent pad in place between said portable carrier and said insert so it cannot be removed by a dog.

12. The combination according to claim 1, further comprising a hook on at least one of said sidewalls, said hook adapted to holding a waste scoop.

13. The combination according to claim 1, further comprising a device to treat air adjacent said combination to eliminate odor.

14. The combination according to claim 1, wherein said device is powered by electric power.

15. The combination according to claim 1, further comprising magnets to secure said door to said portable carder.
